(19) United States
(12) Patent Application Publication
(10) Pub. No.: US 2014/0030474 A1
(43) Pub. Date: Jan. 30, 2014

(54) LEATHER PROTECTIVE COVER

(71) Applicant: Fu-Yi HSU, Taitung County (TW)

(72) Inventor: Fu-Yi HSU, Taitung County (TW)

(21) Appl. No.: 13/561,658

(22) Filed: Jul. 30, 2012

(51) Int. Cl. B32B 3/04

(52) U.S. Cl. 428/99; 428/189; 428/195.1

(57) ABSTRACT

A leather protective cover for electronic device includes a base, a spine, and a folding cover. The base has a first support portion and a second support portion. The first support portion has a first adhesive layer, and the second support portion is bendably connected to the first support portion. The spine is bendably connected to the base. The folding cover is bendably connected to the spine. The second support portion and the first support portion are capable of defining a first predetermined angle, and the second support portion and the folding cover are capable of defining a second predetermined angle. Thus, the electronic device can be configured at an appropriate viewing angle.

### BACKGROUND OF THE INVENTION

1. Field of the Invention

The instant disclosure relates to a leather protective cover; more particularly, to a leather protective cover for electronic devices.

2. Description of Related Art

With the launch of “The New Generation Tablet PC” by Microsoft, along with the debut of iPhone by Apple in 2007, touchscreen technology is ever expanding. First used by the military and other special applications, the touchscreens have subsequently become familiar in everyday life. For example, the touchscreen technology has been used on tablet computers, smart phones, mini notebooks, and other portable electronics. The user can listen to music, play on-line video games, draw, read e-book, watch movies, and surf internet by interfacing through the touchscreen as the primary input device. Such technological advancement has redefined the way people live and work. Therefore, electronics that include touchscreens, which provide visual displays and can detect the presence and location of a touch within the display area, are gaining much popularity among the consumers.

Most protective cases for consumer electronics provide portability and protection against impact and vibration. To use the electronic device, the protective case is opened and laid on a flat support structure. However, users can not adjust the viewing angle of the electronic device through existing protective cases.

Thus, making improvements with protective cases to provide appropriate viewing angle for the user is highly desired.

### SUMMARY OF THE INVENTION

The instant disclosure provides a leather protective cover, which is capable of providing an appropriate viewing angle of electronic devices to the user.

The leather protective cover comprises a base, a spine, and a folding cover. The base has a first support portion and a second support portion. The first support portion has a first adhesive layer. The second support portion being bendably connected to the first support portion. The spine is bendably connected between the base and the folding cover. The second support portion and the first support portion are capable of defining a first predetermined angle, and the second support portion and the folding cover are capable of defining a second predetermined angle.

The instant disclosure further provides a leather protective cover for electronic devices. The leather protective cover comprises an adhesive body, a base, a spine, and a folding cover. The adhesive body having a second adhesive layer disposed on a first surface thereof. The base has a first support portion and a second support portion. The first and second support portions are disposed against a second surface of the adhesive body and the second support portion is bendably connected to the first support portion. The spine is bendably connected between the base and the folding cover. The second support portion and the first support portion are capable of defining a first predetermined angle, and the second support portion and the folding cover are capable of defining a second predetermined angle.

The leather protective cover of the instant disclosure utilizes the first and second predetermined angles to provide an appropriate viewing angle of the electronic device. Thus, the user can operate the electronic device comfortably.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1A is a top perspective view of a leather protective cover according to a first embodiment of the instant disclosure with an electronic device inserted into the cover.

FIG. 1B is a top perspective view of the leather protective cover in FIG. 1A opened to receive the electronic device.

FIG. 1C is a side view of the leather protective cover in FIG. 1A at a completely closed position.

FIG. 2 is a perspective view of the leather protective cover in FIG. 1A folded as a stand.

FIG. 3A is a perspective view of the leather protective cover in FIG. 1A with the electronic device oriented at a tilted position.

FIG. 3B is a side view of the leather protective cover in FIG. 3A.

FIG. 4A is an exploded view of a leather protective cover according to a second embodiment of the instant disclosure opened to receive an electronic device.

FIG. 4B is a top perspective view of the leather protective cover in FIG. 4A with the electronic device inserted into the cover.

FIG. 5 is a side view of a leather protective cover according to a third embodiment of the instant disclosure with the electronic device oriented at a tilted position.

FIG. 6A is an exploded view of a leather protective cover according to a fourth embodiment of the instant disclosure opened to receive an electronic device.

FIG. 6B is a top perspective view of the leather protective cover in FIG. 6A with the electronic device inserted into the cover.

### DETAILED DESCRIPTION OF THE PREFERRED EMBODIMENTS

### First Embodiment

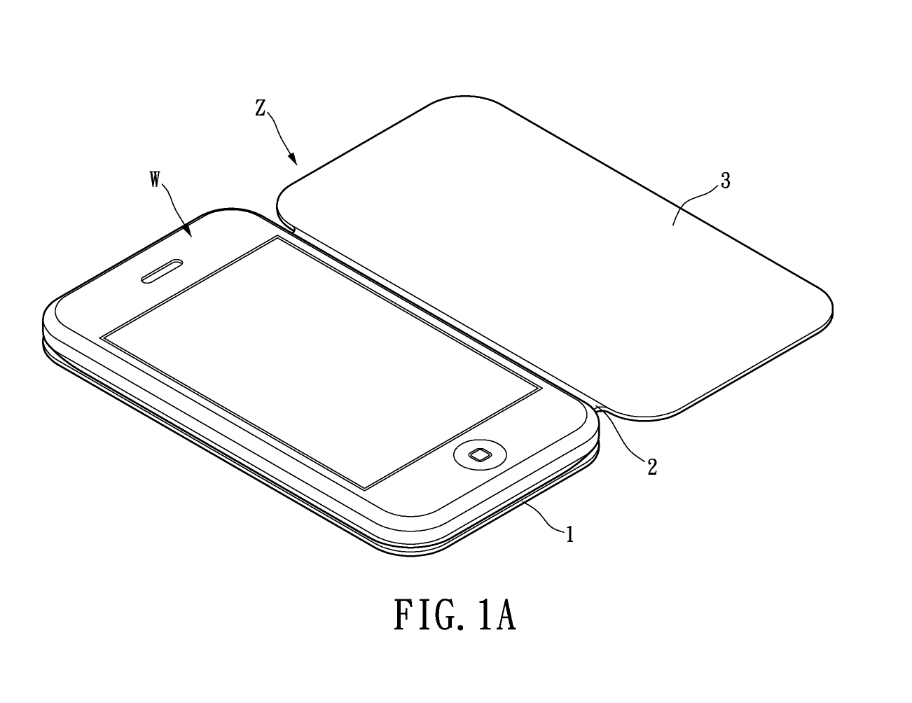

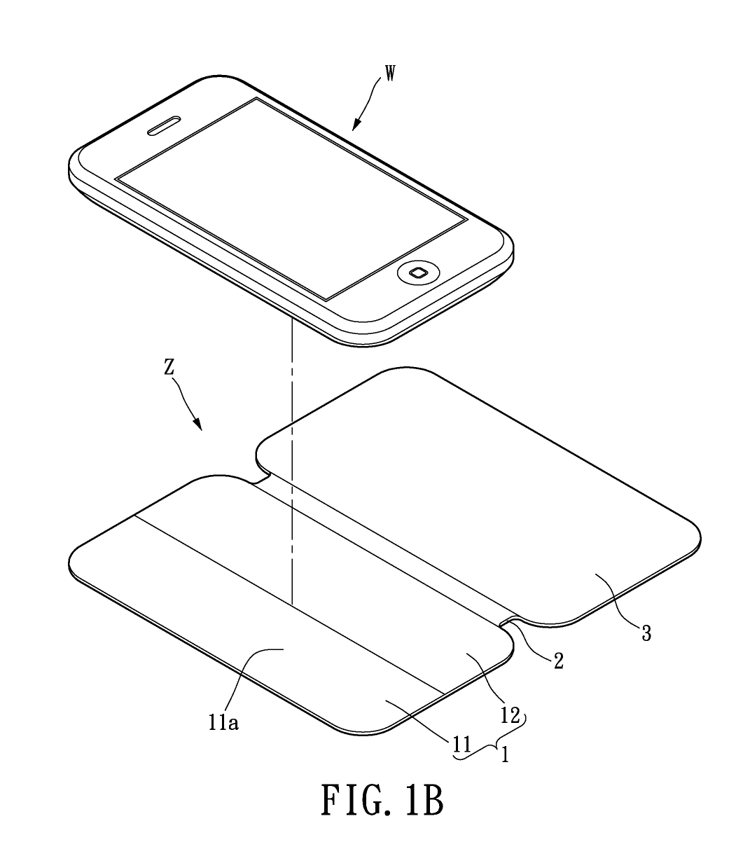

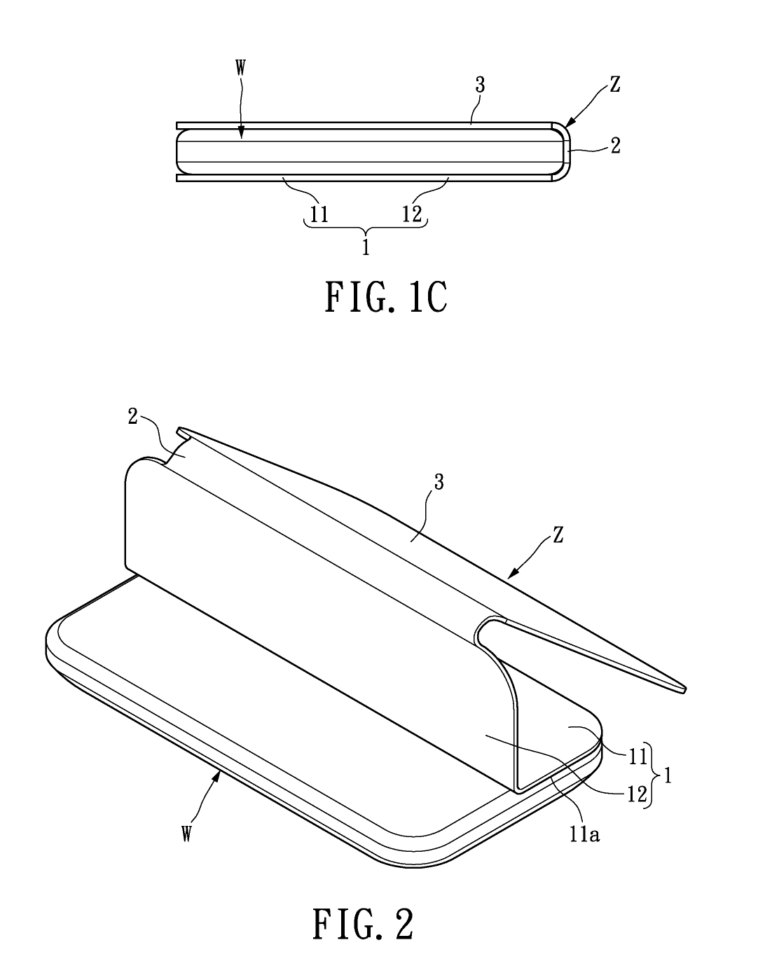

Please refer to FIGS. 1A-2. FIG. 1A is a perspective view showing a leather protective cover Z for a first embodiment of the instant disclosure, where an electronic device represented by the letter W is received by the cover Z. FIG. 1B is a perspective view showing the cover Z opened to receive the electronic device W. FIG. 1C is a side view showing the cover Z at a completely closed position. FIG. 2 is a perspective view showing the cover Z configured to provide a stand for the electronic device W.

The leather protective cover Z comprises a base 1, a spine 2, and a folding cover 3.

The base 1 has a first support portion 11 and a second support portion 12 bendably connected thereto. The first support portion 11 has a first adhesive layer 11a. The first adhesive layer 11a of the first support portion 11 adheres to the electronic device W. Specifically, the first adhesive layer 11a adheres to the bottom surface of the electronic device W. It is to be noted that adhesiveness of the first adhesive layer 11a is determined by the specific operational requirements. For example, the first adhesive layer 11a may be used repeatedly and leaving essentially no residual adhesive on the electronic device W or for one-time use only. Besides, the width of the first support portion 11 and the width of the second support portion 12 each is dimensioned approximately half the width of the base 1. However, the exact widths of the first support portion 11 and the second support portion 12 are configured according to the operational requirements.

The spine 2 is bendably connected between the base 1 and the folding cover 3. For example, the base 1, the folding cover 3, and the spine 2 may be formed integrally. In addition, the sizes (length, width) of the base 1 and the folding cover 3 are dimensioned substantially the same as that of the electronic device W. Whereas the width of the spine 2 can be substantially the same as the thickness of the electronic device W. More specifically, when the leather protective cover Z is closed up, the electronic device W is arranged between the base 1, the spine 2, and the folding cover 3. Thus, the leather protective cover Z can provide protection for the electronic device W. It is to be noted that the folding cover 3 can protect the screen of the electronic device W. The electronic device W can be a mobile phone, PDA, or other portable electronic products. In addition, the base 1, the folding cover 3, and the spine 2 can be made from materials such as natural leather, artificial leather, natural fiber, or man-made fiber. Other materials such as flannel and special non-slip fabric may also be used. The material choice is not restricted.

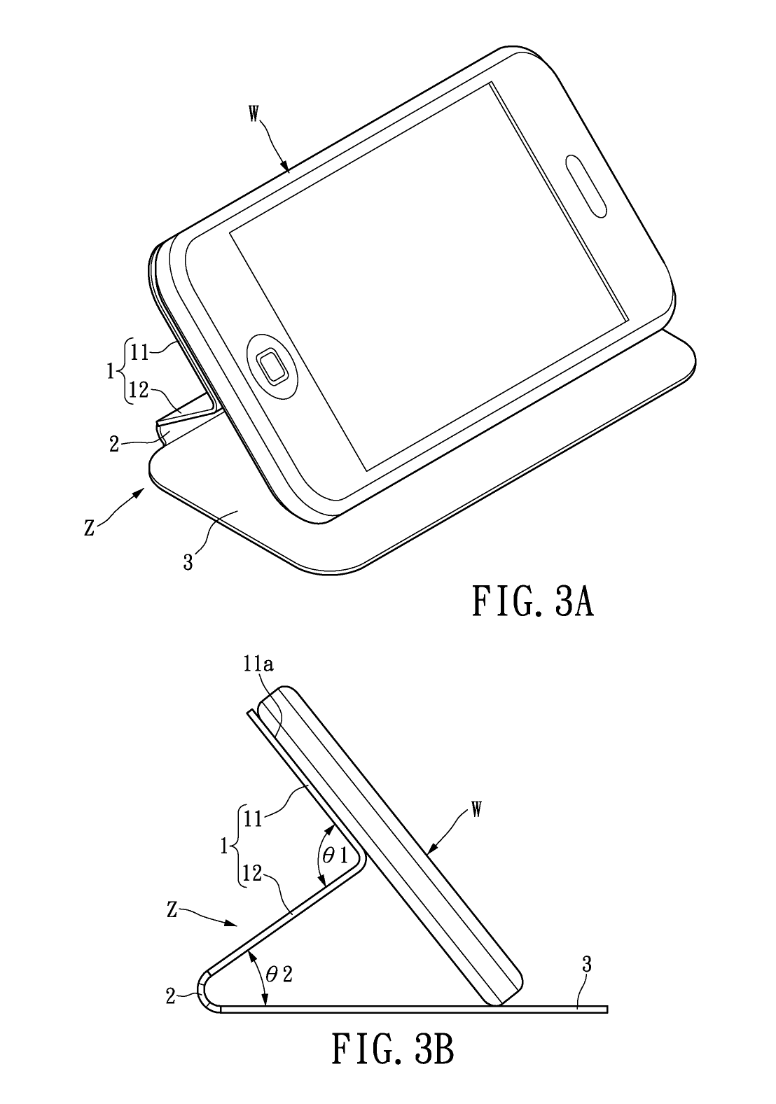

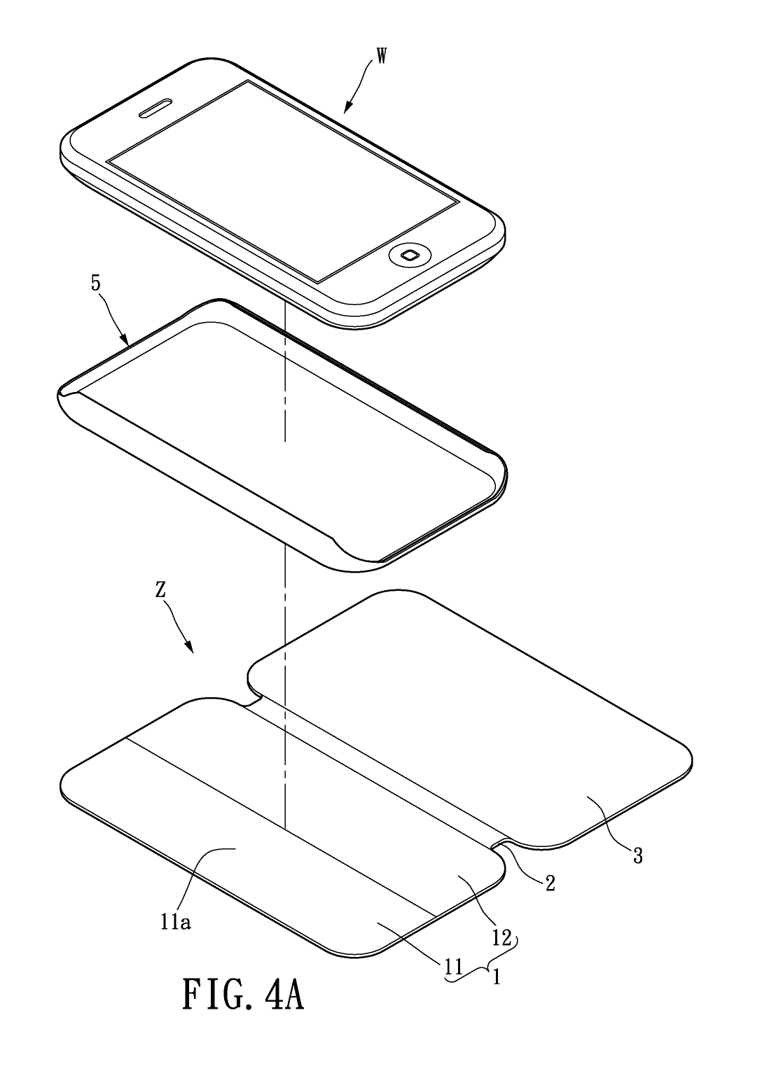

Please refer to FIGS. 3A and 3B. FIG. 3A is a perspective view showing the cover Z as a stand for the electronic device W, while FIG. 3B is a side view of the cover Z in FIG. 3A.

As shown in FIG. 3B, the second support portion 12 and the first support portion 11 are capable in defining a first predetermined angle θ₁, and the second support portion 12 and the folding cover 3 are capable in defining a second predetermined angle θ₂. More specifically, the first predetermined angle θ₁ is formed by bending a bending portion (not labeled) formed between the first and second support portions 11 and 12. The second predetermined angle θ₂ is formed by bending the spine 2. For the illustrated embodiment, the first predetermined angle θ₁ is approximately 90 degrees. The second predetermined angle θ₂ is approximately 45 degrees. In other words, the electronic device W and the folding cover 3 cooperatively define an angle of approximately 45 degrees. Thus, the leather protective cover Z is capable of providing the user with an appropriate viewing angle of the electronic device W via the first and second predetermined angles θ₁, θ₂.

### Second Embodiment

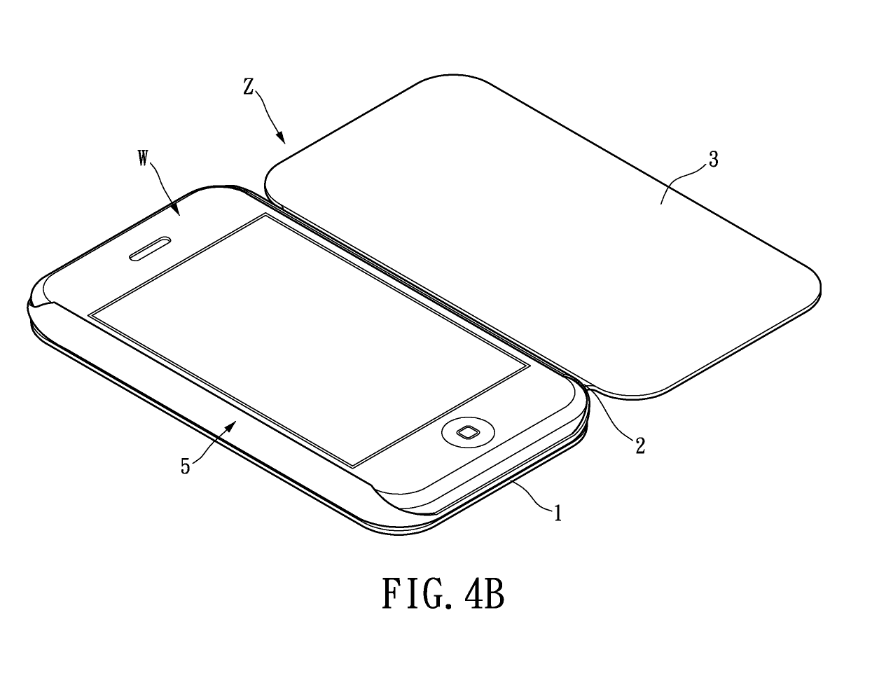

Please refer to FIGS. 4A and 4B. FIG. 4A is an exploded view of the cover Z, and FIG. 4B is a top perspective view of the cover Z with the electronic device W inserted into the cover Z.

By comparing FIG. 4A with FIG. 1B, the difference between the instant embodiment and the previous embodiment is: the leather protective cover Z further comprises a holder 5 for securing the electronic device W. The holder 5 is disposed on the first adhesive layer 11a of the first support portion 11. The holder 5 may be made of polycarbonate (PC) or other plastic materials without restriction.

### Third Embodiment

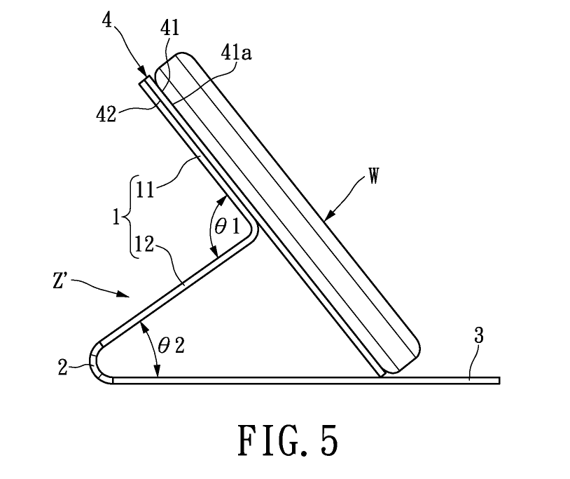

Please refer to FIG. 5, which is a side view showing a leather protective cover Z′ of the instant disclosure oriented as a stand for the electronic device W.

As shown in FIG. 5, the leather protective cover Z′ comprises an adhesive body 4, the base 1, the spine 2, and the folding cover 3. The adhesive body 4 has a second adhesive layer 41a disposed on a first surface 41 thereof. The first support portion 11 of the base 1 is disposed against an oppositely arranged second surface 42 of the adhesive body 4. When the cover Z′ is closed, the second support portion 12 is also arranged against the second surface 42 of the adhesive body 4. The second support portion 12 being bendably connected to the first support portion 11. The spine 2 is bendably connected between the base 1 and the folding cover 3. Likewise, the second support portion 12 and the first support portion 11 are capable in defining the first predetermined angle θ₁, and the second support portion 12 and the folding cover 3 are capable in defining the second predetermined angle θ₂.

By comparing FIG. 5 with FIG. 3B, the difference between the instant embodiment and the first embodiment is: the leather protective cover Z′ further comprises the adhesive body 4. The second adhesive layer 41a is disposed on the first surface 41 of the adhesive body 4 and adheres to the underside of the electronic device W. The first adhesive layer 11a of the first support portion 11 adheres to the second surface 42 of the adhesive body 4. It is to be noted that the adhesive body 4, the base 1, spine 2, and folding cover 3 can be formed integrally in one piece or as a two-piece unit.

### Fourth Embodiment

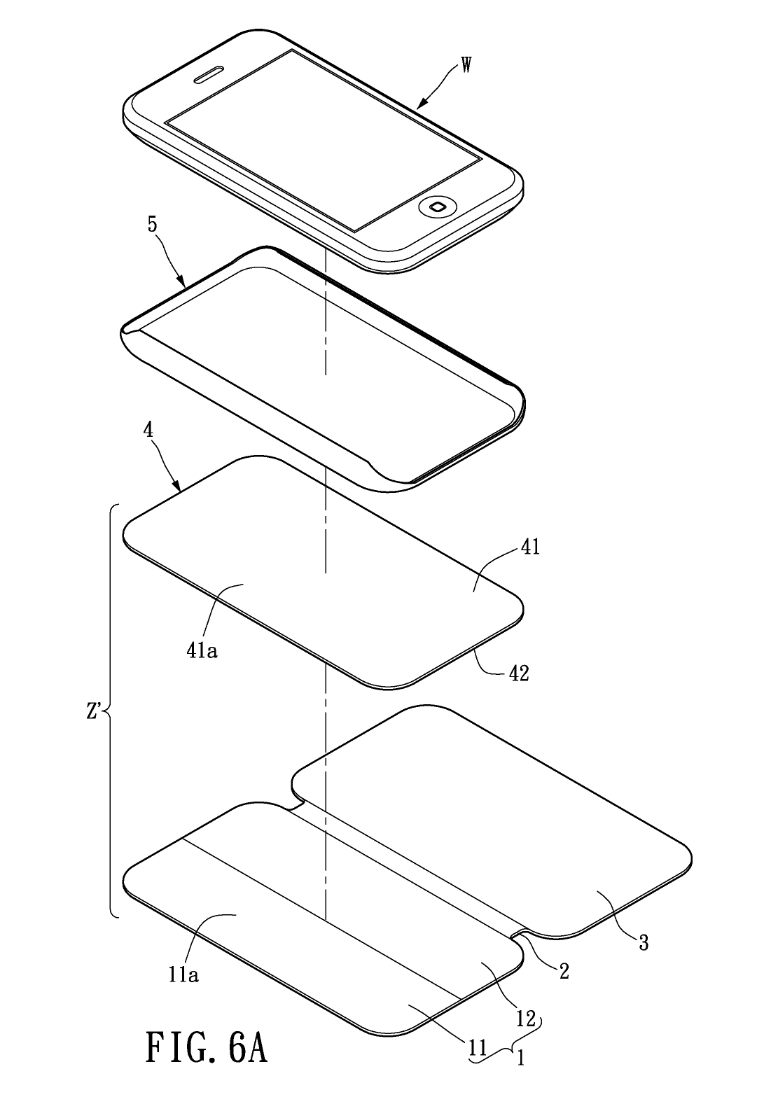

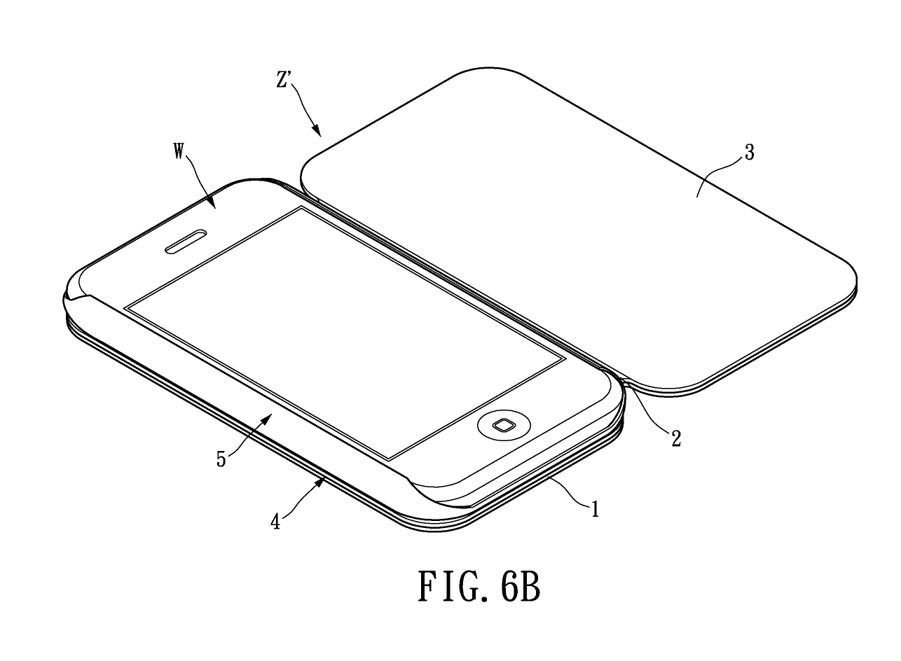

Please refer to FIGS. 6A and 6B. FIG. 6A is an exploded view of the cover Z′ opened to receive the electronic device W. Whereas FIG. 6B is a perspective view of the cover Z′ with the electronic device W inserted into the cover Z′.

By comparing FIG. 6A with FIG. 5, the difference between the instant embodiment and the third embodiment is: the leather protective cover Z′ of the instant embodiment further comprises the holder 5 for receiving the electronic device W. More specifically, the second adhesive layer 41 of the adhesive body 4 adheres to the underside of the holder 5. The holder 5 may be made of polycarbonate (PC) or other plastic materials without restriction.

Based on the foregoing, the leather protective cover of the instant disclosure utilizes the first predetermined angle formed between the first and second support portions and the second predetermined angle formed between the second support portion and the folding cover to provide appropriate viewing angle of the electronic device.

The above-mentioned descriptions represent merely the preferred embodiments of the instant disclosure, without any intention to limit the scope of the instant disclosure thereto. Various equivalent changes, alternations or modifications based on the claims of instant disclosure are all consequently viewed as being embraced by the scope of the instant disclosure.

What is claimed is:

1. A leather protective cover for electronic devices, comprising:
a base having a first support portion and a second support portion bendably connected thereto, the first support portion having a first adhesive layer;
a spine bendably connected to the base; and
a folding cover bendably connected to the spine;
wherein the second support portion and the first support portion are capable of defining a first predetermined angle, and the second support portion and the folding cover are capable of defining a second predetermined angle.

2. The leather protective cover according to claim 1, wherein the first adhesive layer of the first support portion adheres to the electronic device.

3. The leather protective cover according to claim 1, wherein the base, the spine, and the folding cover are formed integrally.

4. The leather protective cover according to claim 1, further comprising a holder for securing the electronic device.

5. The leather protective cover according to claim 4, wherein the first adhesive layer of the first support portion adheres to the holder.

6. A leather protective cover for electronic devices, comprising:
an adhesive body having a second adhesive layer disposed on a first surface thereof;
a base having a first support portion and a second support portion bendably connected thereto, the first support portion and the second support portion being in contact with a second surface of the adhesive body;
a spine bendably connected to the base; and
a folding cover bendably connected to the spine;
wherein the second support portion and the first support portion are capable of defining a first predetermined angle, and the second support portion and the folding cover are capable of defining a second predetermined angle.

7. The leather protective cover according to claim 6, wherein the second adhesive layer of the adhesive body adheres to the electronic device.

8. The leather protective cover according to claim 6, wherein the first support portion has a first adhesive layer.

9. The leather protective cover according to claim 6, further comprising a holder for securing the electronic device.

10. The leather protective cover according to claim 9, wherein the second adhesive layer of the adhesive body adheres to the holder.
